(19) United States
(12) Patent Application Publication
(10) Pub. No.: US 2011/0204735 A1
(43) Pub. Date: Aug. 25, 2011

(54) ELECTRIC CYCLING DYNAMIC SYSTEM

(76) Inventor: Feng-Kuei Chen, Tainan City (TW)

(21) Appl. No.: 12/711,272

(22) Filed: Feb. 24, 2010

(51) Int. Cl. H02K 47/04; H02K 53/00

(52) U.S. Cl. 310/113; 415/916

(57) ABSTRACT

An electric cycling dynamic system mainly includes a driving motor having one end of its shaft fixed with a generator, which is electrically connected with a rectifier, a battery and a voltage amplifier in series. The voltage amplifier is finally connected electrically with the driving motor. The driving motor is driven by an exterior power source so that the shaft is to simultaneously drive the generator to rotate to create electricity, which is rectified by the rectifier before stored in the battery. Then by means of the voltage amplifier, the electricity stored in the battery can be stepped up to a voltage level needed and fed back to the driving motor. So with a less exterior power source, electrical power can be continuously generated by the driving motor for its own use, indeed lowering consumption of energy and carbon emission.

### BACKGROUND OF THE INVENTION

1. Field of the Invention

This invention relates to an electric cycling dynamic system, particularly to one provided with a driving motor having one side of a shaft fixed with a generator utilized to generate electricity while being driven by the driving motor by an exterior power source. Then the electricity is consecutively rectified by a rectifier, stored in a battery, raised to a needed voltage .level by a voltage amplifier, and fed back to the driving motor, forming a continuous cycle of dynamics to the driving motor.

2. Description of the Prior Art

All kinds of mechanical facilities, such as motorcycles, automobiles and machine tools etc, are widely used in contemporary rapid-developing era. They are usually driven by motors that have to consume electric power or fuels. Gasoline is the main fuel burned to provide dynamics for a car. However, carbon dioxide generated by combustion of gasoline is to severely pollute the air. A great amount of carbon emission can also be generated even if using electric power or other fuels. Combustion of fuels means not only expending a lot of money, but also posing a worse global warming to threaten ecologically.

### SUMMARY OF THE INVENTION

The object of this invention is to offer an electric cycling dynamic system. Electricity can be stored in a battery, fed back to a driving motor so as to save exterior power source, indeed lowering consumption of energy and carbon emission.

A first characteristic of the electric cycling dynamic system is a driving motor having one side of a shaft fixed with a generator, which is electrically connected to a rectifier, a battery and a voltage amplifier in series. Finally the voltage amplifier is connected to the driving motor. The driving motor is driven by an exterior power source so that the shaft is to simultaneously drive the generator to rotate to create electricity, which is rectified by the rectifier before stored in the battery. Then by means of the voltage amplifier, the electricity stored in the battery can be stepped up to a voltage level needed by the driving motor, fed back to drive the driving motor. So with a less exterior power source, electrical power can be continuously generated by the driving motor for its own use, indeed lowering consumption of energy and carbon emission.

A second characteristic of the electric cycling dynamic system is a driving motor having one side of a shaft fixed with a generator and another side fixed with a transmitting mechanism. The generator is electrically connected to a rectifier, a battery and a voltage amplifier in series. Finally the voltage amplifier is electrically connected to the driving motor. The driving motor is driven by an exterior power source so that the shaft is to simultaneously drive the transmitting mechanism and the generator to rotate to create electricity, which is rectified by the rectifier before stored in the battery. Then by means of the voltage amplifier, the electricity stored in the battery can be stepped up to a voltage level needed by the driving motor, fed back to drive the driving motor. So with a less exterior power source, electrical power can be continuously generated by the driving motor for its own use to drive the transmitting mechanism, indeed lowering consumption of energy and carbon emission.

### BRIEF DESCRIPTION OF DRAWINGS

This invention is better understood by referring to the accompanying drawings, wherein:

FIG. 1 is a componential block diagram of a first preferred embodiment of an electric cycling dynamic system in the present invention;

FIG. 2 is a functional flow chart of the first preferred embodiment of an electric cycling dynamic system in the present invention;

FIG. 3 is a componential block diagram of a second preferred embodiment of an electric cycling dynamic system in the present invention; and

FIG. 4 is a functional flow chart of the second preferred embodiment of an electric cycling dynamic system in the present invention.

### DETAILED DESCRIPTION OF THE PREFERRED EMBODIMENT

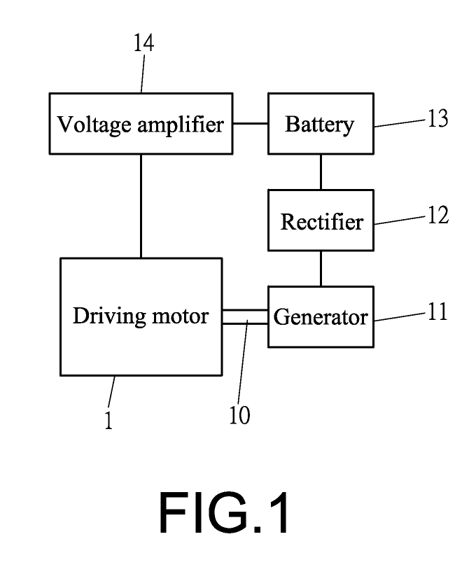

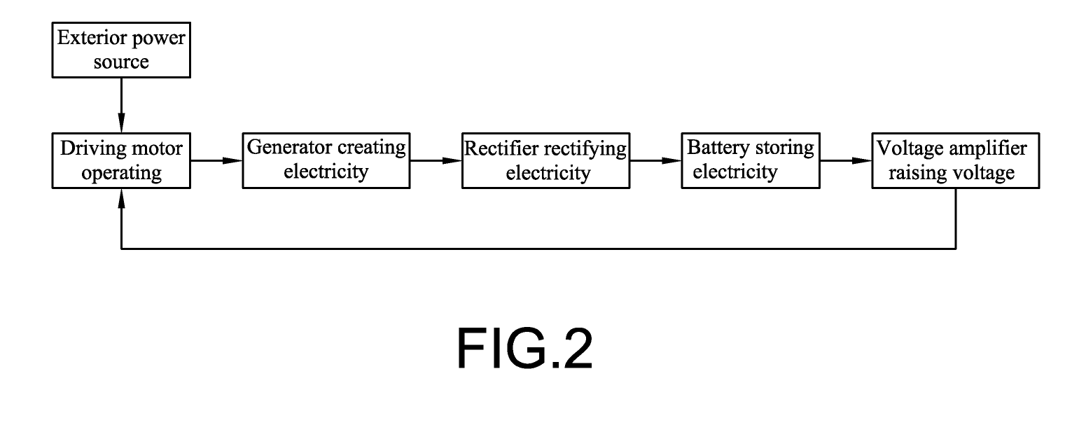

As shown in FIGS. 1 and 2, a first preferred embodiment of an electric cycling dynamic system in the present invention mainly includes a driving motor 1 installed in a mechanical means, such as a motorcycle, a car or a machine tool etc, a generator 11 fixed on one side of a shaft 10 of the driving motor 1, a rectifier 12 connected electrically to the generator 11, a battery 13 and a voltage amplifier 14 connected electrically in series with the generator. Finally the voltage amplifier 14 is connected to the driving motor 1.

In this embodiment, an exterior power source is provided to drive the driving motor 1, so that the shaft 10 is to simultaneously drive the generator 11 to rotate to create electricity, which is rectified by the rectifier 12 before stored in the battery 13. Then by means of the voltage amplifier 14, the electricity stored in the battery 13 can be stepped up to a voltage level needed by the driving motor 1, fed back to drive the driving motor 1. Therefore electrical power can be continuously generated by the driving motor 1 for its own use as long as the driving motor 1 is driven by a less electric power of exterior source, indeed lowering consumption of energy and carbon emission, achieving a purpose of lessening pollution to the air.

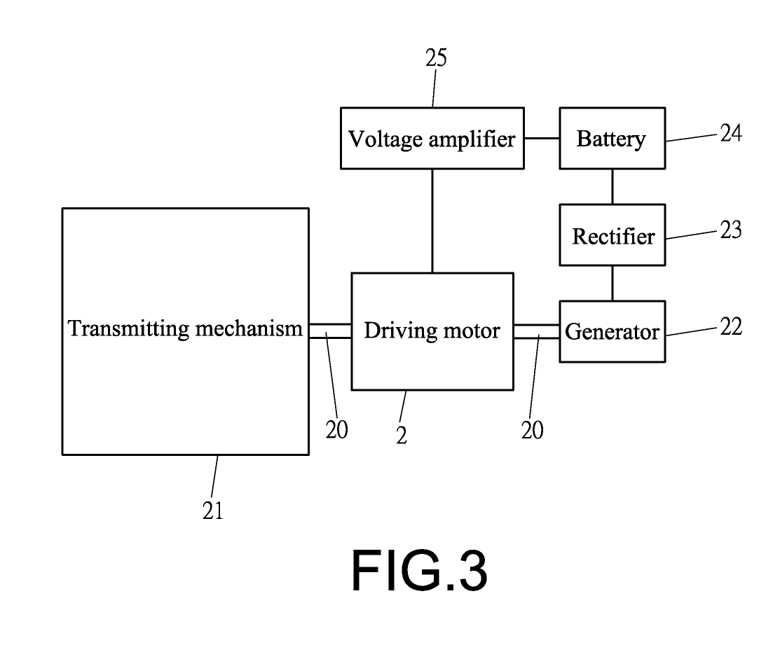

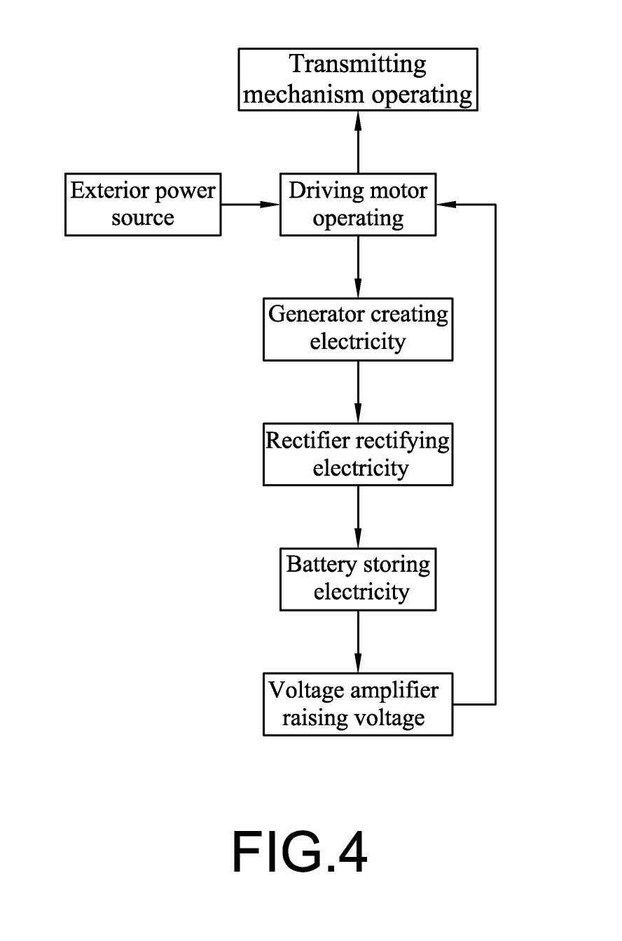

As shown in FIGS. 3 and 4, a second preferred embodiment of an electric cycling dynamic system in the present invention mainly includes a driving motor 2 installed in a mechanical means, such as a motorcycle, a car or a machine tool etc, a transmitting mechanism 21 fixed on one side of a shaft 20 of the driving motor 2, a generator 22 fixed on another side of the shaft 20, a rectifier 23 electrically connected to the generator 22, a battery 24 and a voltage amplifier 25 electrically connected in series with the generator 22. Finally the voltage amplifier 25 is electrically connected to the driving motor 2.

In this embodiment, an exterior power source is provided to drive the driving motor 2, so that the shaft 20 is to simultaneously drive the transmitting mechanism 21 and the generator 22 to rotate to create electricity, which is rectified by the rectifier 23 before stored in the battery 24. Then by means of the voltage amplifier 25, the electricity stored in the battery 24 can be stepped up to a voltage level needed by the driving motor 2, fed back to drive the driving motor 2. Therefore electrical power can be continuously generated by the driving motor 2 for its own use to drive the transmitting mechanism 21 as long as the driving motor 2 is driven by a less electric power of exterior source, indeed lowering consumption of energy and carbon emission, achieving a purpose of lessening pollution to the air.

While the preferred embodiment of the invention has been described above, it will be recognized and understood that various modifications may be made therein and the appended claims are intended to cover all such modifications that may fall within the spirit and scope of the invention.

What is claimed is:

1. An electric cycling dynamic system comprising a driving motor having a generator fixed on one side of a shaft, said generator further electrically connected to a rectifier that is connected to a battery and a voltage amplifier in series, said voltage amplifier finally connected electrically to said driving motor, said driving motor driven by an exterior power source so that said shaft is to simultaneously drive said generator to rotate to create electricity that is rectified by said rectifier before stored in said battery, electric energy of said battery stepped up to a needed voltage level by said voltage amplifier for being used by said driving motor, thus electric power continuously generated by said driving motor.

2. An electric cycling dynamic system comprising a driving motor having a transmitting mechanism fixed on one side of a shaft of said driving motor and a generator fixed on another side of said shaft, said generator further electrically connected to a rectifier that is electrically connected to a battery and a voltage amplifier in series, said voltage amplifier finally connected to said driving motor, said driving motor driven by an exterior power source so that said shaft is to simultaneously drive said transmitting mechanism and said generator to rotate to create electricity that is rectified by said rectifier before stored in said battery, electric energy of said battery stepped up to a needed voltage level by said voltage amplifier for being used by said driving motor, thus electric power continuously generated by said driving motor to drive said transmitting mechanism.
